(19) United States
(12) Patent Application Publication
(10) Pub. No.: US 2018/0089675 A1
(43) Pub. Date: Mar. 29, 2018

(54) MOBILE DEVICE AUTHENTICATION

(71) Applicant: NCR Corporation, Duluth, GA (US)

(72) Inventor: Jeffrey Stephen Cooper, Kitchener (CA)

(21) Appl. No.: 15/280,414

(22) Filed: Sep. 29, 2016

(51) Int. Cl. G06Q 20/40; G06Q 20/10; G06Q 20/32; G06K 9/46

(52) U.S. Cl. CPC G06Q 20/401; G06Q 20/102; G06K 2209/01; G06K 9/4671; G06Q 20/3227

(57) ABSTRACT

Various embodiments herein each include at least one of systems, methods, software, and data structures for mobile device authorization of checks written on a checking account by an authorized individual. One embodiment, in the form of a method, includes receiving input with regard to a check within an authorized account session for the account on which the check is drawn. The session, in some embodiments, is an authenticated session within a mobile device application. The method further includes storing the received input to authorize payment on the check when data of the check is received for payment processing.

### BACKGROUND INFORMATION

Personal checks have fallen out of favor for a number of reasons. These reasons include the fact that checks can be somewhat easily counterfeited based on the information printed directly on the face of a check. When a counterfeit check is presented, the check is processed and fraud against the account holder occurs. One solution to this has been positive pay where business use software to print checks and data of the checks is transmitted for each check or for a group of checks to a financial institution preauthorizing payment on the checks represented in and according to the data. When check data is subsequently received for processing payment on a check, the preauthorized check data is consulted and the payment approved or denied based on whether there is a match. Such positive pay solutions have generally not been available to individuals who typically write out checks by hand make entries in a handwritten check register.

### SUMMARY

Various embodiments herein each include at least one of systems, methods, software, and data structures for mobile device authorization of checks written on a checking account by an authorized individual.

One embodiment, in the form of a method, includes receiving input with regard to a check within an authorized account session for the account on which the check is drawn. The session, in some embodiments, is an authenticated session within a mobile device application. The method further includes storing the received input to authorize payment on the check when data of the check is received for payment processing.

Another method embodiment includes receiving an image of a check and transmitting the check image over a network to a network location for positive pay data generation. This method further includes receiving positive pay data in response to the transmitting of the check image and presenting the received positive pay data within a user interface with a request for verification and correction, if needed. The method may then receive verification input including any needed corrections and then transmit verification including data of any needed corrections with regard to the check over the network to the network location for storage as positive pay data to authorize payment on the check from an account on which the check is drawn.

A further embodiment, in the form of a system includes at least one network interface device, at least one processor, and at least one memory storing instructions executable by the at least one processor to perform data processing activities. The data processing activities, in some embodiments, include receiving input with regard to a check within an authorized account session for the account on which the check is drawn and storing the received input to authorize payment on the check when data of the check is received for payment processing.

### BRIEF DESCRIPTION OF THE DRAWINGS

FIG. 1 is a logical block diagram of a system architecture, according to an example embodiment.

FIG. 2 is a block diagram of a computing device, according to an example embodiment.

FIG. 3 is a block flow diagram of a method, according to an example embodiment.

FIG. 4 is a block flow diagram of a method, according to an example embodiment.

FIG. 5 is a block flow diagram of a method, according to an example embodiment.

### DETAILED DESCRIPTION

Although the various embodiments herein are useful to most banking customer, in the current banking environment, the various embodiments are particularly useful to retail customers and small businesses that typically do not print checks with a computer, but instead handwrite checks. As such banking customers are not using computers to generate their check, they lack the opportunity to generate a positive pay file that is submitted to the financial institution on which their checks are drawn to preauthorize checks when they are presented for payment. The embodiments herein provide a mobile device solution, such as may be included in a mobile banking app, that may be used to capture an image of a handwritten check. The mobile device app may then submit the check image over a network to an optical character recognition (OCR) process or even perform OCR process on the mobile device, in some embodiments. The OCR process may then store data captured from the check image along with the check image as positive pay data. However, in some embodiments, the OCR data may be transmitted back to the mobile device to receive confirmation and correction with regard to that data, which may then be stored back over the network to the financial institution as positive pay data with regard to the check.

These and other embodiments are described herein with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

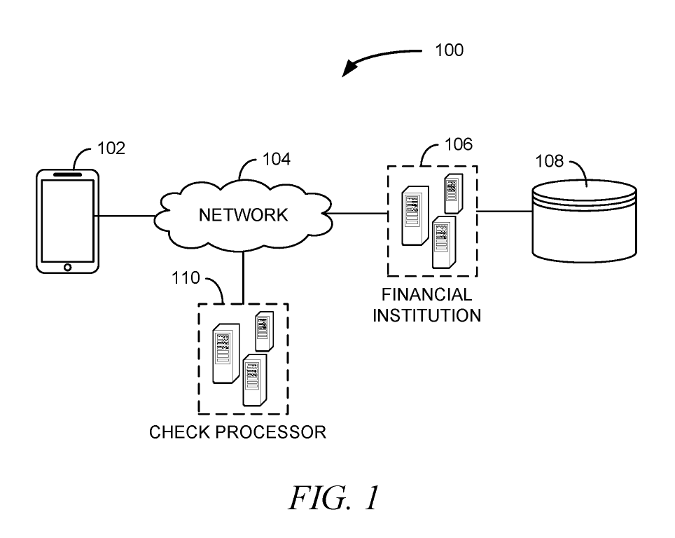

FIG. 1 is a logical block diagram of a system 100 architecture, according to an example embodiment. The system 100 is an example of a system on which some embodiments may be implemented. The system 100 is presented in a greatly simplified form as including only a single mobile device 102 on which an app, such as a banking account holder mobile app, executes. Many such mobile devices 102 are present in typical embodiments. Further, some embodiments may include computing systems 106, 110 of multiple financial institutions and check processor along with a plurality of databases 108.

The mobile device 102 generally connects to a network 104, which may include the Internet. Also connected to the network 104 are the computing systems 106, 110 of a financial institution and a check processor. In operation, according to some embodiments, the mobile device 102 is the device of a banking customer of the financial institution that operates the computing system 106. The mobile device 102 includes a mobile banking app of the financial institution. The banking customer authenticates using the mobile device 102 app and enters a functional portion of the app to generate positive pay data to preauthorize the financial institution to make payment on a check written by the customer. The app is used to capture an image of the check with an imaging device (e.g., a digital camera) of the mobile device 102. The check image is then submitted for OCR processing. The OCR processing, in some embodiments, is performed on the mobile device 102. However, in other embodiments, the OCR processing is performed on the computing systems 106 of the financial institution and then data output by the OCR processing may be returned to mobile device 102 app or simply stored in the database 108 as positive pay data when the check processor 110 computing systems subsequently present data of the check for payment. In embodiments where the OCR processing is performed on or the OCR data is returned to the mobile device 102 app, the check data may then be presented within a user interface on a display of the mobile device.

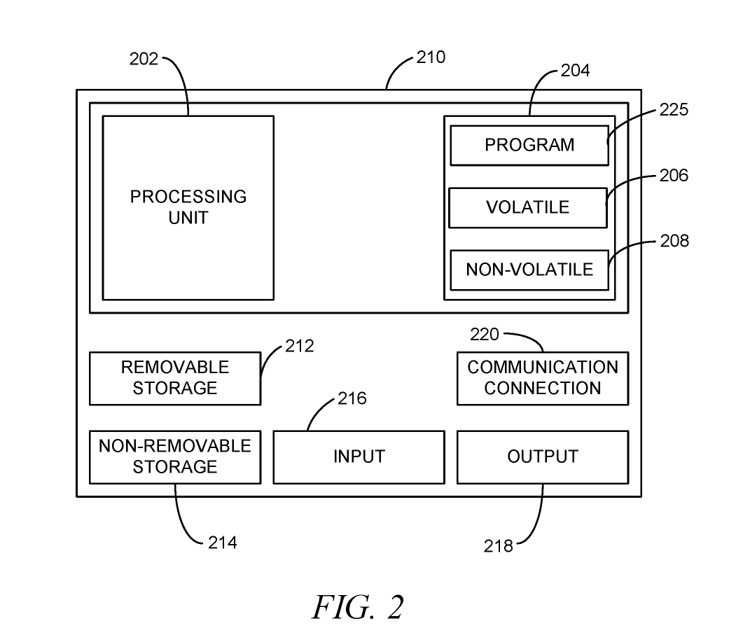

FIG. 2 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 210, may include a processing unit 202, memory 204, removable storage 212, and non-removable storage 214. Although the example computing device is illustrated and described as computer 210, the computing device may be in different forms in different embodiments. For example, the computing device may instead be a smartphone, a tablet, smartwatch, or other computing device including the same or similar elements as illustrated and described with regard to FIG. 2. Devices such as smartphones, tablets, and smartwatches are generally collectively referred to as mobile devices. Further, although the various data storage elements are illustrated as part of the computer 210, the storage may also or alternatively include cloud-based storage accessible via a network, such as the Internet.

Returning to the computer 210, memory 204 may include volatile memory 206 and non-volatile memory 208. Computer 210 may include—or have access to a computing environment that includes a variety of computer-readable media, such as volatile memory 206 and non-volatile memory 208, removable storage 212 and non-removable storage 214. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 210 may include or have access to a computing environment that includes input 216, output 218, and a communication connection 220. The input 216 may include one or more of a touchscreen, touchpad, mouse, keyboard, camera, one or more device-specific buttons, one or more sensors integrated within or coupled via wired or wireless data connections to the computer 210, and other input devices. The computer 210 may operate in a networked environment using a communication connection 220 to connect to one or more remote computers, such as database servers, web servers, and other computing device. An example remote computer may include a personal computer (PC), server, router, network PC, a peer device or other common network node, or the like. The communication connection 220 may be a network interface device such as one or both of an Ethernet card and a wireless card or circuit that may be connected to a network. The network may include one or more of a Local Area Network (LAN), a Wide Area Network (WAN), the Internet, and other networks. In some embodiments, the communication connection 220 may also or alternatively include a transceiver device, such as a BLUETOOTH® device that enables the computer 210 to wirelessly receive data from and transmit data to other BLUETOOTH® devices.

Computer-readable instructions stored on a computer-readable medium are executable by the processing unit 202 of the computer 210. A hard drive (magnetic disk or solid state), CD-ROM, and RAM are some examples of articles including a non-transitory computer-readable medium. For example, various computer programs 225 or apps, such as one or more applications and modules implementing one or more of the methods illustrated and described herein or an app or application that executes on a mobile device or is accessible via a web browser, may be stored on a non-transitory computer-readable medium.

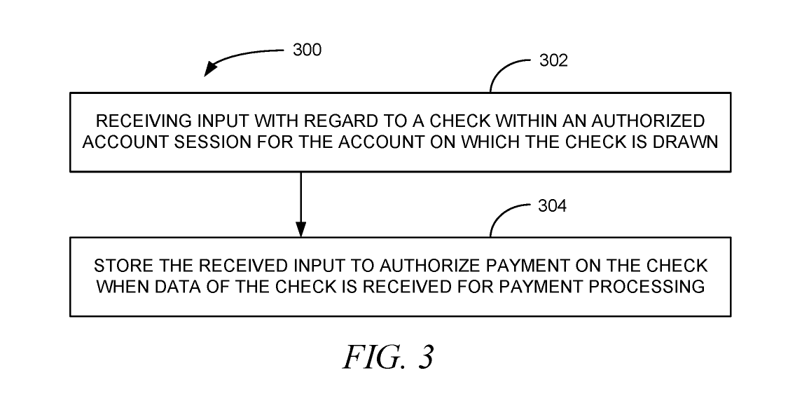

FIG. 3 is a block flow diagram of a method 300, according to an example embodiment. The method 300 is a method that maybe performed on either or both of the mobile device 102 and the financial institution computing system 106 of FIG. 1. The method 300 includes receiving 302 input with regard to a check within an authorized account session for the account on which the check is drawn. The method 300 further includes storing 304 the received input to authorize payment on the check when data of the check is received for payment processing.

In some embodiments, the input is received 302 as an image of the check. Some such embodiments further include performing OCR on the check image to obtain data from the check that is to be stored along with the check image to authorize the payment on the check. In some such embodiments, the data obtained from performing OCR on the check image includes a check amount and check serial, routing, and account numbers. Some other embodiments receive this data as human input into a computing device, such as an account holder mobile device. In such human input embodiments, a check image may not be received in some instances.

In some further embodiments of the method 300, the input is received 302 via a network by a computing system, such as the financial institution computing system 106, from a mobile device app. In some such embodiments, the method 300 further includes transmitting at least a portion of the data obtained from the check by performance of the optical character recognition over the network to the mobile device with a request for verification and correction, if needed. Such verification of the check data, which may include one or more corrections, may then be received via the network from the mobile device app.

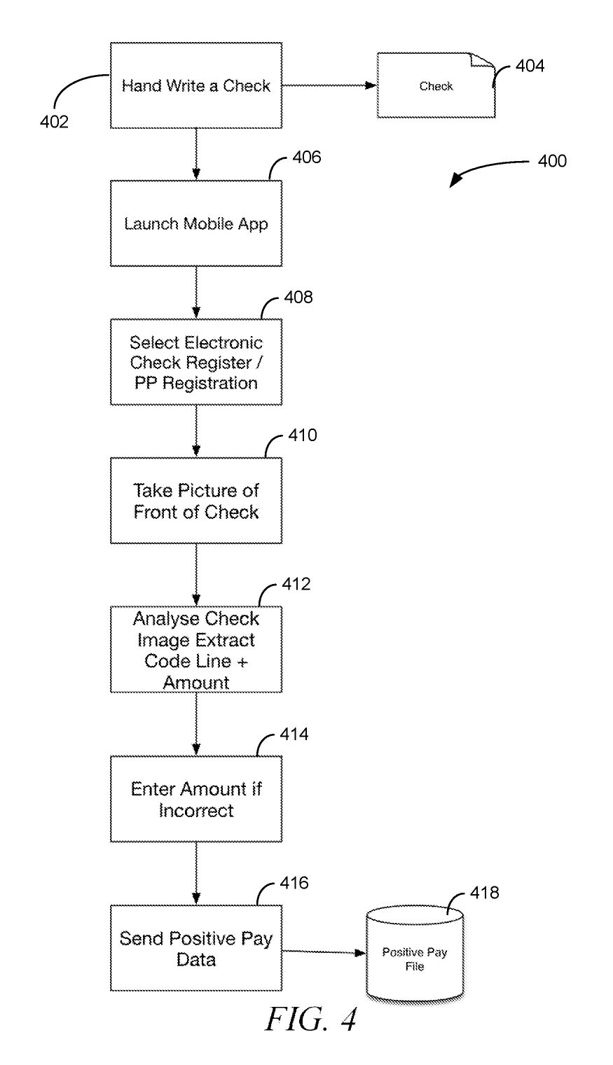

FIG. 4 is a block flow diagram of a method 400, according to an example embodiment. The method 400 is an example method that is performed primarily within an app that executes on a mobile device to generate positive pay data to authorize payment on a check written by an individual authorized to draft checks on a checking account. The method 400 includes the individual hand writing 402 a check 404. The individual may then launch 406 a mobile app on their mobile device, such as a mobile banking app of a bank holding the checking account on which the check is drawn.

Within the mobile app that has been launched 406, the individual may then select 408 an electronic check register or positive pay portion of the app to be presented. Within that portion of the app, the individual then selections a function to take a picture of at least the front of the check 404. The check 404 image is then analyzed 412, such as by performance of OCR on the check 404 image, to extract data such as the check amount and the code line at the bottom of the check that typically includes the check 404 number, the bank routing number, and the checking account number. The analyzing 412 may be performed on the mobile device performing the method 400 or may be offloaded from the mobile device to a cloud location, which may be on the financial institution computing systems or elsewhere. The method 400 may further present the extracted check 404 data to the individual. When the presented data is not accurate, the individual may enter 414 corrected data, such as a corrected amount. The method 400 then proceeds to send 416 positive pay data in a positive pay file 418 to an appropriate repository for storage until needed when the check 404 is presented for payment.

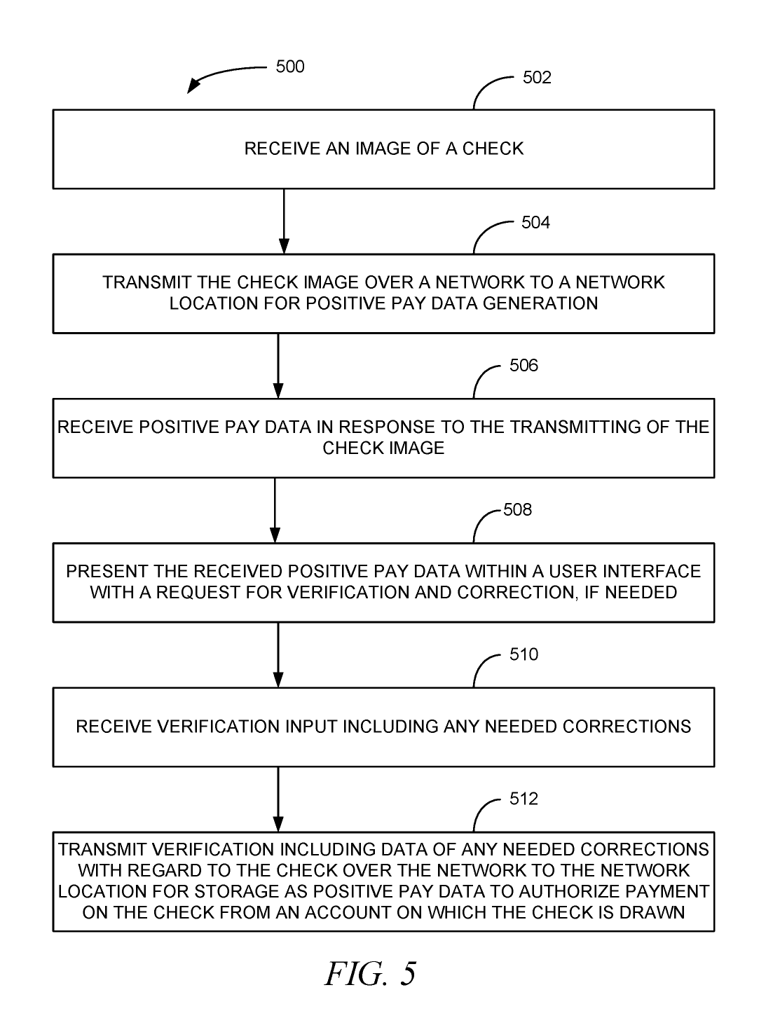

FIG. 5 is a block flow diagram of a method 500, according to an example embodiment. The method 500 is another example of a method that may be performed on a mobile device to generate positive pay data to preauthorized a financial institution to make payment on a check when presented.

The method 500 includes receiving 502 an image of a check and transmitting 504 the check image over a network to a network location for positive pay data generation. The method 500 further includes receiving 506 positive pay data in response to the transmitting of the check image and presenting 508 the received positive pay data within a user interface with a request for verification and correction, if needed. Verification, including any needed corrections, is received 510. The method 500 then transmits 512 verification including data of any needed corrections with regard to the check over the network to the network location for storage as positive pay data to authorize payment on the check from an account on which the check is drawn.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
receiving input with regard to a check within an authorized account session for the account on which the check is drawn;
storing the received input to authorize payment on the check when data of the check is received for payment processing.

2. The method of claim 1, wherein the input is received as an image of the check, the method further comprising:
performing optical character recognition on the check image to obtain data from the check that is to be stored along with the check image to authorize the payment on the check.

3. The method of claim 2, wherein the data obtained from performing the optical character recognition on the check image includes a check amount and check serial, routing, and account numbers.

4. The method of claim 2, wherein the input is received via a network from a mobile device app.

5. The method of claim 4, further comprising:
transmitting at least a portion of the data obtained from the check by performance of the optical character recognition over the network to the mobile device with a request for verification and correction, if needed.

6. The method of claim 5, further comprising:
receiving verification of the check data via the network from the mobile device app.

7. The method of claim 6, wherein the received verification includes at least one correction to the check data.

8. A method comprising:
receiving an image of a check;
transmitting the check image over a network to a network location for positive pay data generation;
receiving positive pay data in response to the transmitting of the check image;
presenting the received positive pay data within a user interface with a request for verification and correction, if needed;
receiving verification input including any needed corrections; and
transmitting verification including data of any needed corrections with regard to the check over the network to the network location for storage as positive pay data to authorize payment on the check from an account on which the check is drawn.

9. The method of claim 8, wherein the method is performed within a mobile device app that executes on a mobile device.

10. The method of claim 9, wherein the check image is received from an imaging device of the mobile device.

11. The method of claim 9, wherein the mobile device app is an app of a financial institution holding the account on which the check is drawn.

12. A system comprising:
at least one network interface device;
at least one processor;
at least one memory storing instructions executable by the at least one processor to perform data processing activities, the data processing activities comprising:
receiving input with regard to a check within an authorized account session for the account on which the check is drawn;
storing the received input to authorize payment on the check when data of the check is received for payment processing.

13. The system of claim 12, wherein the input is received as an image of the check, the data processing activities further comprising:
performing optical character recognition on the check image to obtain data from the check that is to be stored along with the check image to authorize the payment on the check.

14. The system of claim 13, wherein the data obtained from performing the optical character recognition on the check image includes a check amount and check serial, routing, and account numbers.

15. The system of claim 13, wherein the input is received via a network from a mobile device app.

16. The system of claim 15, the data processing activities further comprising:
transmitting at least a portion of the data obtained from the check by performance of the optical character recognition over the network to the mobile device with a request for verification and correction, if needed.

17. The system of claim 16, the data processing activities further comprising:
receiving verification of the check data via the network from the mobile device app.

18. The system of claim 17, wherein the received verification includes at least one correction to the check data.

19. The system of claim 13, wherein the system is a mobile device.

20. The system of claim 19, wherein the data processing activities are performed by a mobile device app that executes on the mobile device.
